(19) United States
(12) Patent Application Publication
(10) Pub. No.: US 2010/0250728 A1
(43) Pub. Date: Sep. 30, 2010

(54) METHOD FOR CONTROLLING WEB PAGE OPERATION IN BROWSER/SERVER ARCHITECTURE

(75) Inventors: Xue Min Zhang, Tianjin (CN); Tom Chen, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei (TW)

(21) Appl. No.: 12/411,946

(22) Filed: Mar. 26, 2009

(51) Int. Cl. G06F 15/16

(52) U.S. Cl. 709/224

(57) ABSTRACT

A method for controlling a web page operation in browser/server architecture is adapted to prevent the same page from being operated by more than one people at the same time. The method includes establishing a status record table for recording a usage status of web page by server; checking usage status of web page in status record table after server receiving a request for operating the web page from a second browser; accepting request and submitting an operation control right of the web page to second browser if the usage status is idle; sending a check message to first browser to check whether first browser is still using the web page or not if usage status in status record table indicates that web page is used by first browser; rejecting request and transmitting usage status of web page to second browser if first browser is still using the web page.

### BACKGROUND OF THE INVENTION

1. Field of Invention

The present invention relates to a method for controlling a web page operation, and more particularly to a method for preventing the same web page from being operated by more than one people at the same time in browser/server (B/S) architecture.

2. Related Art

Browser/server (B/S) architecture is a system architecture constituted by a browser and a server, which is modified or improved based on client/server (C/S) architecture along with the emergence and development of the Internet technology. In the C/S architecture, a user interface is realized through a World Wide Web (WWW) browser, a minor portion of business logic is implemented by a browser, and the major portion of business logic is implemented by a server, forming a 3-tier architecture. Thus, the load on the user computer, the cost and workload for system maintenance and upgrade, as well as the total cost of ownership (TCO) are greatly reduced.

In the current C/S architecture, mechanisms for preventing the same document or file from being operated by more than one user at the same time have already been developed, such as Microsoft Word and Excel. When more than one user opens the same file, all users except for the user that opens the file at the earliest time will be notified that the file is currently in a read-only status. Such a mechanism can conveniently notify the users and solve the problem of inconsistent file contents when the file is saved after modification. However, at present, such mechanisms cannot be found under the B/S architecture. When more than one user processes the same data presented via browsers, a user may input many data, but find that other users have also made modifications to the data when the user submits the data, and thus fails to save the data. Otherwise, the data modified by other users will be overwritten; as a result, the data integrity cannot be maintained.

### SUMMARY OF THE INVENTION

Accordingly, the present invention is a method for controlling a web page operation in browser/server (B/S) architecture, in which when a web page in a server is operated by a first browser, the server checks a status record table after a second browser requests for operating the web page, and responds whether the second browser has an operation control right to the web page or not according to a check result.

Therefore, in the method for controlling a web page operation in browser/server (B/S) architecture of the present invention, when a web page in a server is operated by a first browser, the server performs a check after a second browser requests for operating the web page. The method comprises: establishing a status record table for recording a usage status of the web page by the server; checking the usage status of the web page in the status record table by the server after receiving a request for operating the web page from the second browser; accepting the request and submitting an operation control right of the web page to the second browser by the server if the usage status of the web page is idle; sending a check message to the first browser by the server to check whether the first browser is still using the web page or not if the usage status of the web page is operating; and rejecting the request of the second browser and transmitting the usage status of the web page to the second browser by the server if the first browser responds to the check message and the first browser is still using the web page.

Here, fields of the status record table comprise a web page name, a web page path, an update time, a usage status, and a user name. The web page name is used for storing a name of the web page. The web page path is used for storing a path of the web page. The update time is used for storing time when the web page is operated. The usage status is used for storing a current usage status of the web page. The user name is used for storing a name of a browser operating the web page.

In addition, after the step of sending the check message to the first browser by the server, the method further comprises: updating a record of a usage status of the web page of the second browser in the status record table and submitting the operation control right of the web page to the second browser if the first browser does not respond to the check message.

Moreover, after the step of sending the check message to the first browser by the server, the method further comprises: updating a record of a usage status of the web page of the second browser in the status record table and submitting the operation control right of the web page to the second browser if the first browser responds to the check message and the first browser is not using the web page.

The present invention provides a method for controlling a web page operation in B/S architecture, which enables a sever to control requests for operating the web page from different browsers by utilizing the status record table corresponding to the web page, thus maintaining the data integrity of the web page.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a method for controlling a web page operation in browser/server (B/S) architecture according to an embodiment of the present invention;

FIG. 2 is a flow chart of the process for checking the status of a first browser according to an embodiment of the present invention; and

FIG. 3 is a flow chart of the process for checking the status of the first browser according to an embodiment of the present invention.

### DETAILED DESCRIPTION OF THE INVENTION

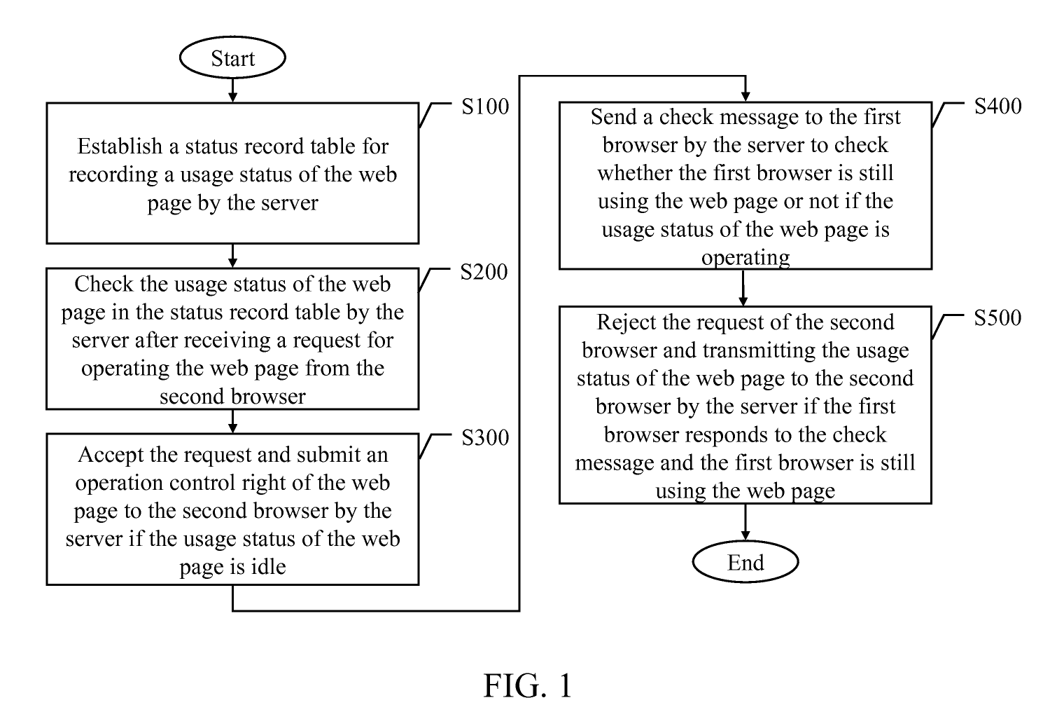

FIG. 1 is a flow chart of a method for controlling a web page operation in browser/server (B/S) architecture according to an embodiment of the present invention. Referring to FIG. 1, the method comprises the following steps.

In Step S100, a server establishes a status record table for recording a usage status of the web page.

In Step S200, the server checks the usage status of the web page in the status record table after receiving a request for operating the web page from a second browser.

In Step S300, if the usage status of the web page is idle, the server accepts the request and submits an operation control right of the web page to the second browser.

In Step S400, if the usage status of the web page is operating, the server sends a check message to the first browser to check whether the first browser is still using the web page or not.

In Step S500, if the first browser responds to the check message and the first browser is still using the web page, the server rejects the request of the second browser and transmits the usage status of the web page to the second browser.

In addition, Table 1 is a status record table according to an embodiment of the present invention. Here, fields of the status record table may comprise a web page name, a web page path, an update time, a usage status, and a user name. The web page name is used for storing a name of the web page. The web page path is used for storing a path of the web page. The update time is used for storing time when the web page is operated. The usage status is used for storing a current usage status of the web page. The user name is used for storing a name of a browser operating the web page.

TABLE 1
Status Record Table

| | Web Page | | | Usage | |
|---|---|---|---|---|---|
| No. | Name | Web Page Path | Update Time | Status | User Name |
| 001 | project.jsp | manager/jsp/product/ | 2008/12/15 | Operating | First browser |
| | | | 08:10:15 | | |
| 002 | product.jsp | manager/jsp/product/ | 2008/12/15 | Idle | Second browser |
| | | | 08:20:35 | | |
| . . . | . . . | . . . | . . . | . . . | . . . |

Herein, the fields of the status record table may be set and adjusted as required.

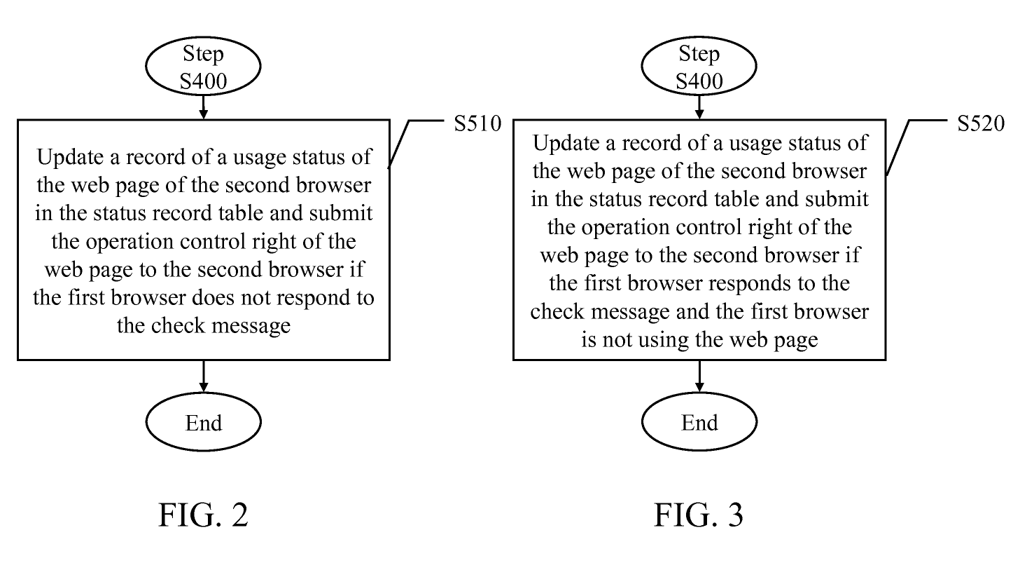

FIG. 2 is a flow chart of the process for checking the status of the first browser according to an embodiment of the present invention. Referring to FIG. 2, after Step S400, the method may comprise the following step:

In Step S510, if the first browser does not respond to the check message, a record of a usage status of the web page of the second browser in the status record table is updated and the operation control right of the web page is submitted to the second browser.

FIG. 3 is a flow chart of the process for checking the status of the first browser according to an embodiment of the present invention. Referring to FIG. 3, after Step S400, the method may comprise the following step:

In Step S520, if the first browser responds to the check message and the first browser is not using the web page, a record of a usage status of the web page of the second browser in the status record table is updated and the operation control right of the web page is submitted to the second browser.

What is claimed is:

1. A method for controlling a web page operation in browser/server (B/S) architecture, wherein when a web page in a server is operated by a first browser, the server performs a check after a second browser requests for operating the web page, the method comprising:
establishing a status record table for recording a usage status of the web page by the server;
checking the usage status of the web page in the status record table by the server after receiving a request for operating the web page from the second browser;
accepting the request and submitting an operation control right of the web page to the second browser by the server if the usage status of the web page is idle;
sending a check message to the first browser by the server to check whether the first browser is still using the web page or not if the usage status of the web page is operating; and
rejecting the request of the second browser and transmitting the usage status of the web page to the second browser by the server if the first browser responds to the check message and the first browser is still using the web page.

2. The method for controlling a web page operation in browser/server (B/S) architecture according to claim 1, wherein fields of the status record table comprise:
a web page name, for storing a name of the web page;
a web page path, for storing a path of the web page;
an update time, for storing time when the web page is operated;
a usage status, for storing a current usage status of the web page; and
a user name, for storing a name of the browser operating the web page.

3. The method for controlling a web page operation in browser/server (B/S) architecture according to claim 1, wherein after the step of sending the check message to the first browser by the server, the method further comprises:
updating a record of a usage status of the web page of the second browser in the status record table and submitting the operation control right of the web page to the second browser if the first browser does not respond to the check message.

4. The method for controlling a web page operation in browser/server (B/S) architecture according to claim 1, wherein after the step of sending the check message to the first browser by the server, the method further comprises:
updating a record of a usage status of the web page of the second browser in the status record table and submitting the operation control right of the web page to the second browser if the first browser responds to the check message and the first browser is not using the web page.
